(19) United States
(12) Patent Application Publication
(10) Pub. No.: US 2009/0232588 A1
(43) Pub. Date: Sep. 17, 2009

(54) Fastening Mechanism

(76) Inventor: Peng Chew Goh, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/908,727

(22) PCT Filed: Apr. 30, 2005
(86) PCT No.: PCT/SG2005/000135

§ 371 Date: Jun. 11, 2008

(30) Foreign Application Priority Data
Mar. 15, 2005 (SG) 200501575-5

(51) Int. Cl. F16B 7/06

(52) U.S. Cl. 403/44

(57) ABSTRACT

A fastening mechanism for connecting posts or other objects together is described. The mechanism consists of a housing (101), a first and second cam (110, 111) oppositely mounted in the housing (101), the first cam (110) and second cams (111) having opposed threads. A threaded stud (105) having clockwise (121) and counter clockwise (122) portions connects the first cam (110) and second cams (111) allowing the cams to be drawn together in use.

### FIELD OF THE INVENTION

This invention relates to a fastening mechanism for connecting posts or other items together the fastening mechanism is particularly suited for use were it is desirable that the mechanism can be tightened and inserted from either side.

### BACKGROUND

Many type of fasteners exist, simple screws may be used to fasten two objects together screws do not however provide force from both sides. Nuts and bolts do provide support from both sides but require access to both sides of the objects to be fastened. While there are fasteners that provide force from both sides that can be inserted from one side, the mechanism used means that the fasteners are not easily removed for reuse. Additionally the fasteners cannot be tightened from either side.

### SUMMARY OF THE INVENTION

It is an object of the present invention to provide a fastening mechanism, which provides force from both sides, can be removed for reuse and can be tightened from either side, or which will at least provide the public or industry with a useful choice.

Accordingly in a first embodiment the present invention consists in a fastening mechanism for connecting posts or other objects together consisting of:

a housing;

a first and second cam oppositely mounted in said housing, said first and second cams having opposed threads; and

a threaded stud having clockwise and counter clockwise portions, said threaded stud connecting said first and second cams allowing said cams to be drawn together in use.

Preferably each said cam has at least one flange in use said at least one flange of said first cam and said at least one flange of said second cam being substantially parallel.

Preferably said at least one flange is two flanges.

Preferably said housing in use prevents said first and second cam rotating relative to each other.

Preferably rotation prevention means in said housing for said first and second cams are offset to allow in use said first and second cams to be drawn closely together.

Preferably said housing is made of mild steel and powder coated.

Preferably cams are made of mild steel and chrome plated.

Preferably said cams are made of mild steel and blackened.

Preferably said housing comprises first and second shells.

Preferably said first and second shells are held together by clips.

Preferably said housing includes rotation prevention means and said housing and said rotation prevention means comprises one pair of offset slots for each said cam, said housing including ends to prevent each said cam from being accidentally withdrawn from said housing

Preferably said first and second shells are made of nylon.

Accordingly in a second embodiment the present invention consists in a method of fastening posts or other objects together using the fastening mechanism described above wherein each said cam has a pair of flanges, in use said pair of flanges of said first cam and said pair of flanges of said second cam being substantially parallel, said method comprising the steps of:

passing a first said cam and part of said housing through a hole in a first and second post, said hole being sized and shaped to allow said cam flanges and said housing to pass through;

turning said fastening device in said hole so that said cam flanges are not aligned with said hole; and

turning said threaded stud to bring said cams together, said cam flanges pulling said posts together.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF DRAWINGS

A fastening mechanism in accordance with the invention will now be described by way of example with reference to the accompanying drawings in which:—

FIG. 1 shows an isometric disassembled view of the fastening mechanism of the present invention;

FIG. 2 shows an isometric view of the assembled fastening mechanism of the present invention;

FIG. 3 shows a back view of the assembled fastening mechanism of the present invention;

FIG. 4 shows a front view of the assembled fastening mechanism of the present invention;

FIG. 5 shows a side view of the assembled fastening mechanism of the present invention;

FIG. 6A to 6D show the use of the fastening mechanism of the present invention to connect two posts together;

FIG. 7 shows an front view of the assembled fastening mechanism of the present invention in use connecting two posts together;

FIG. 8 shows an isometric disassembled view of an alternative embodiment of the fastening mechanism of the present invention;

FIG. 9 shows an isometric view of an alternative embodiment of the assembled fastening mechanism of the present invention; and

FIG. 10 shows an isometric disassembled view of an alternative body of the fastening mechanism of the present invention;

### DETAILED DESCRIPTION OF THE INVENTION

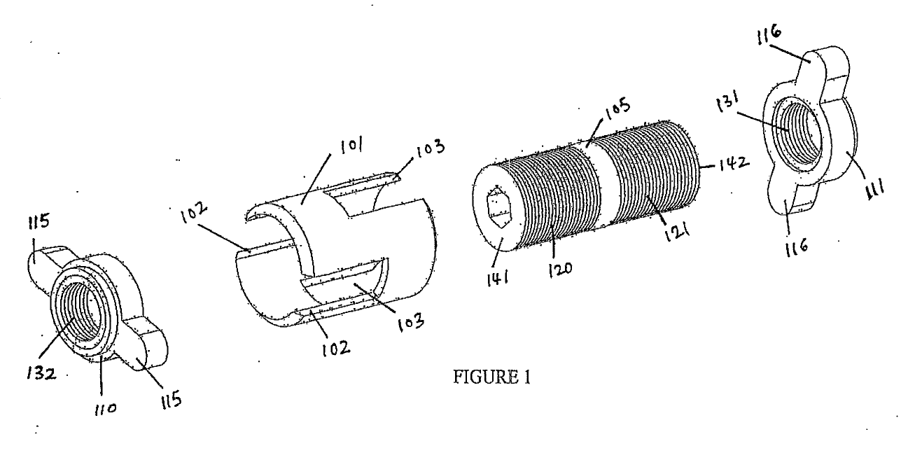

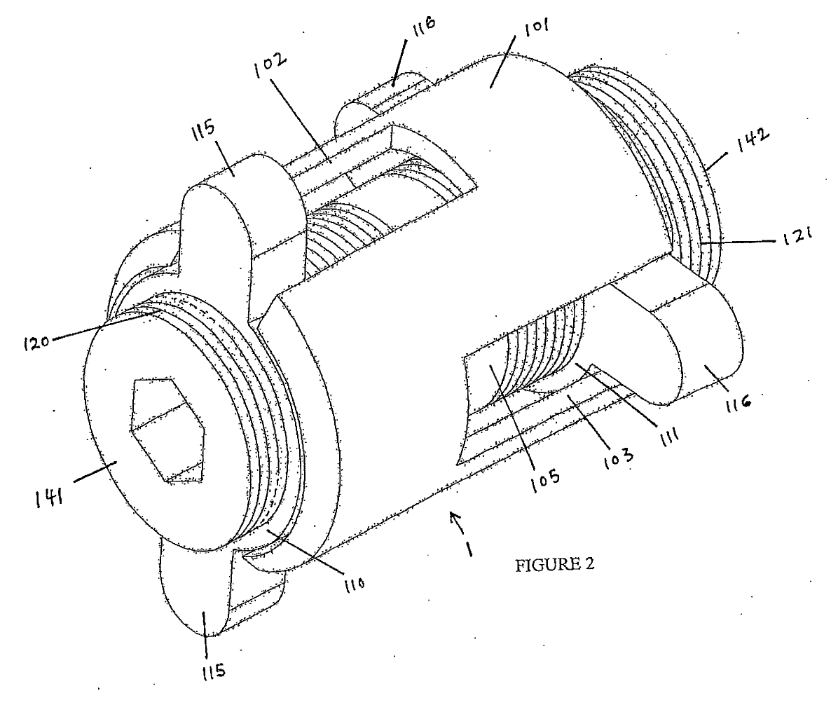

Referring to FIGS. 1 and 2 in the preferred embodiment, and with reference to FIG. 1 the present invention consists of a housing 101. The housing 101 is in the preferred embodiment circular and has two pairs of offset channels 102, 103. The pairs of offset channels preferably overlap. Within the housing a threaded stud 105 having clockwise 121 and anti clockwise 122 threads is located.

Cams 110, 111 being substantially circular and having a pair of flanges 115, 116 located at either end of the housing 101. In use the flanges 115, 116 of each cam 110, 111 move in the offset channels as the cams are pulled towards each other. In one embodiment of the invention the four flanges 115, 116 are offset at approximately 90 degrees as are the channels but they may be spaced any way so long as the pairs of flanges are not aligned. While the invention has been described with two flanges any number of flanges would be suitable. So for example one or three flanges and therefore one or three channels in the housing would be used.

The cams are threaded 131, 132 and in use are threaded on to opposite ends 141, 142 of the threaded stud 105. As the threaded stud 105 is turned in one direction both cams 110, 111 move together or apart simultaneously. The movement either together or apart occurs because substantially one half of the threaded stud 105 has a counterclockwise 122 thread and the other half of the thread stud has a clockwise 121 thread.

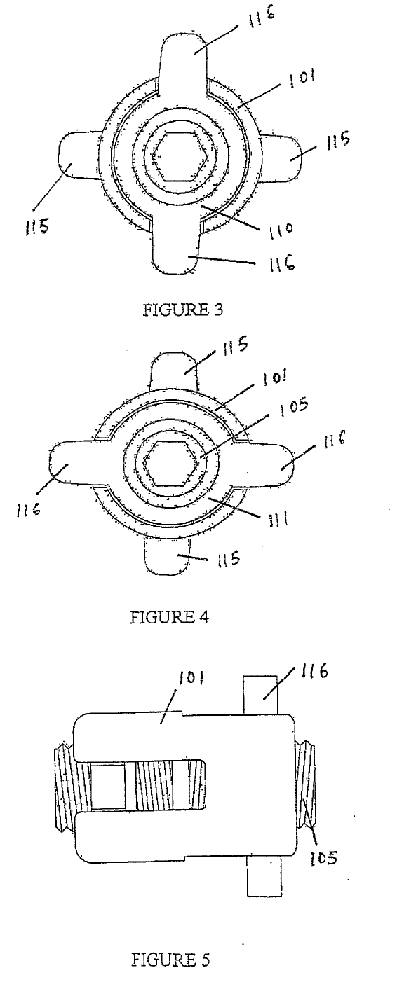

Referring to FIGS. 3 to 5 the flanges 115, 116 are offset because of their location in the channels 102, 103. Because the flanges 115, 116 are offset the cams 110, 111 when tightened can be bought very close together.

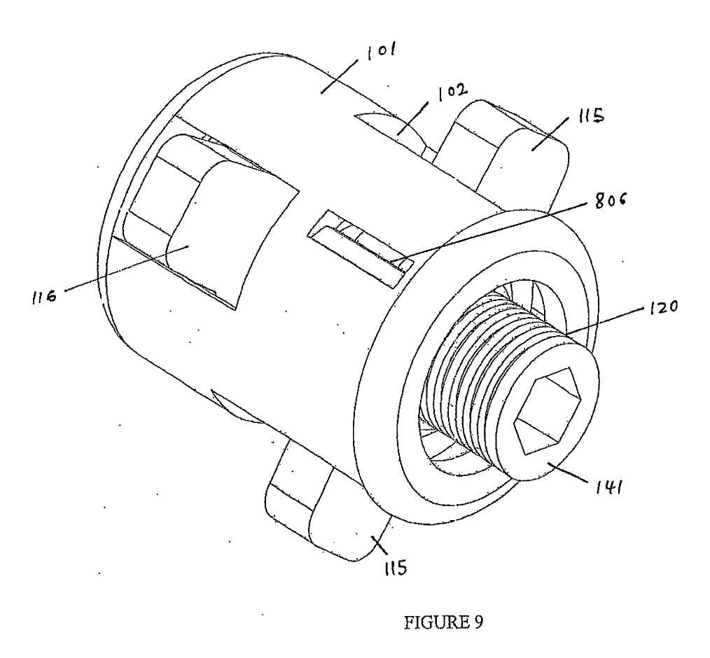

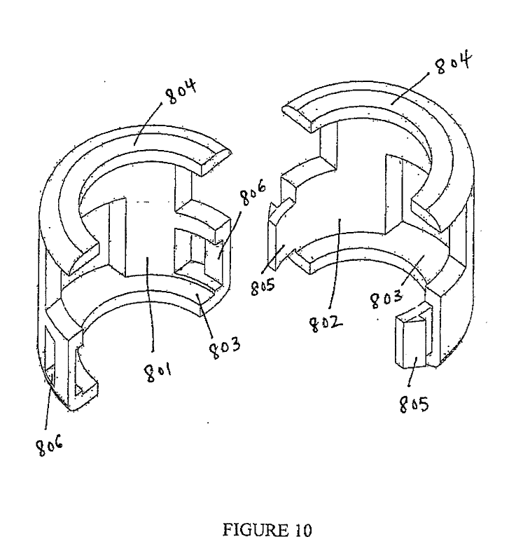

Referring to FIG. 7 to use the fastening mechanism 1 of the present invention the two objects to be fastened together must have a hole 601 that is shaped to allow the body of the fastening mechanism and a pair of cams to pass from one side to the other. Preferably said holes are sufficiently large to allow the cams 110, 111 and the body 101 to pass through when the holes 601 in the two objects are nearly aligned.

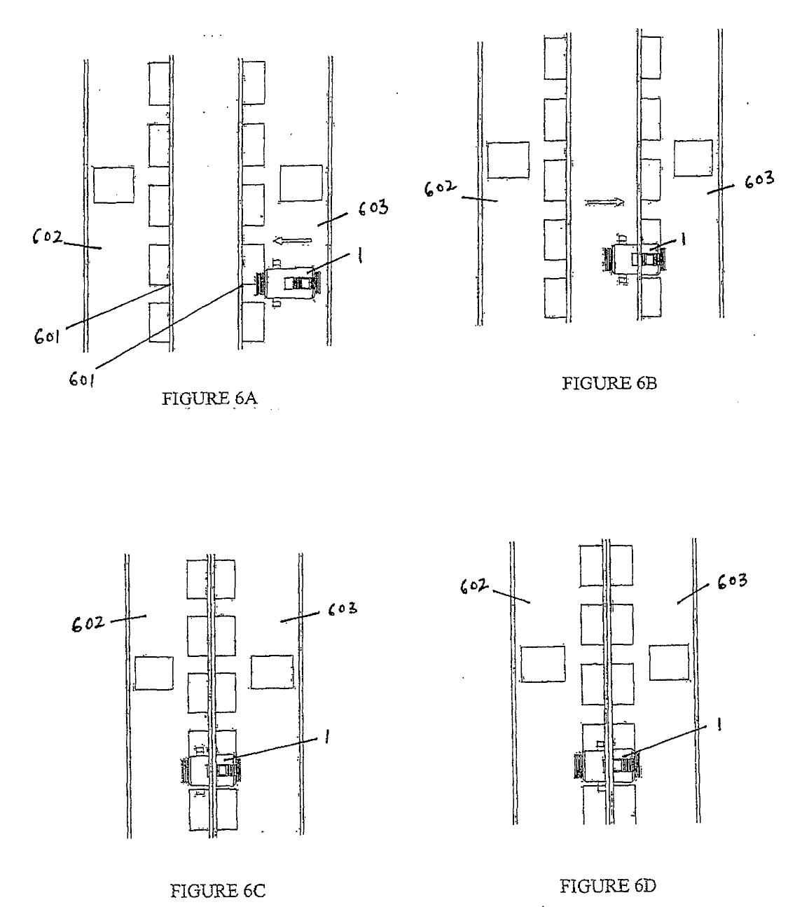

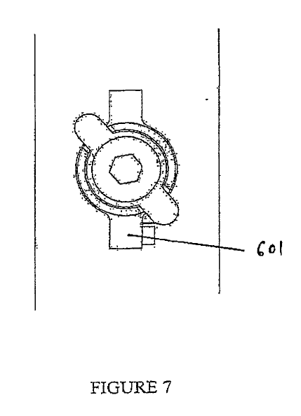

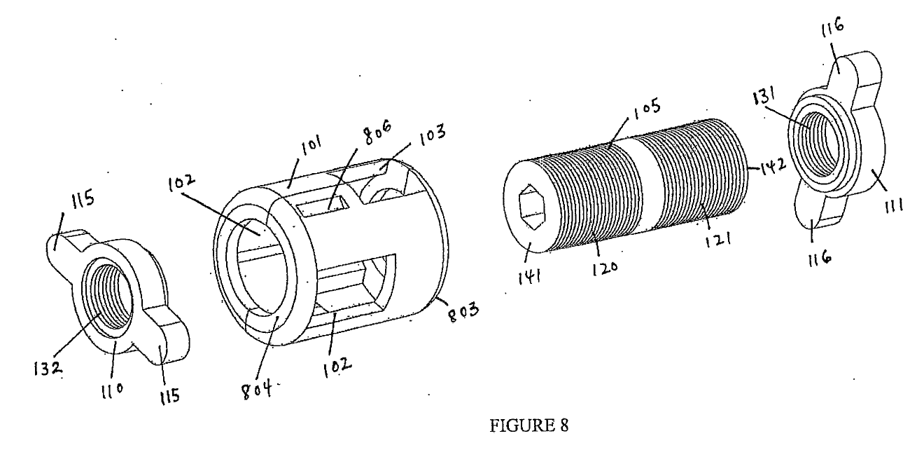

Referring to FIGS. 6A to 6D use of the present invention will be described. The present invention is particularly suited for connecting posts used in office partitions together. The two objects 602, 603 are brought together, part of the fastening mechanism 1 body 101 and a pair of flanges 115 are passed through one object 603. The second object 602 is then moved further towards the first object and part of the fastening mechanism body 101 and a pair of flanges 115 are passed through second object 602.

The fastening mechanism 1 is then turned so that none of the flanges 115, 116 are aligned with the insertion hole 601. In the preferred embodiment the fastening mechanism is turned approximately 45 degrees. The threaded stud 105 is then turned bringing the cams 110,111 and therefore the objects 602, 603 together.

In the preferred embodiment the threaded stud 105 is turned using an allen key but slots to allow the use of a slotted or philips type screwdriver could be substituted.

The present invention is particularly suited to situation where access is from the side of one object only. But because the threaded stud 105 may be turned from either end the most convenient access may be used.

To remove the fastener the threaded stud 105 is turned the opposite way to release the cams 110, 111 allowing the fastening mechanism body 101 and two flanges 115 or 116 to be removed.

A further advantage is that fastening mechanism can be manufactured using a die-casting process. The housing 101 is preferably made of mild steel and powder coated to increase the aesthetic value. The cams 110, 111 are also preferable made mild steel and powder coated to increase the aesthetic value. The threaded stud 105 is preferably made of mild steel and finished using a chrome plate or blackening. The preferred materials will reduce increase the durability of the fastening mechanism.

Referring to FIGS. 8 9 and 10 and alternative embodiment of the present invention will be described. The housing 101 in this alternative embodiment is made of nylon and comprises two parts or shells 801, 802. To assemble the mechanism one cam is screwed on to each end of the threaded stud 105. The two parts of the housing are then clipped around the stud 105 and cams 110, 111. Because housing 101 in this embodiment has end stop 803, 804 the channels 102, 103 do not go all the way to the end of the housing 101. This has the advantage that the cams 110, 111 cannot accidentally be wound off the threaded stud 105 and of reducing the manufacturing costs. To keep the two parts 801, 802 of the housing 101 together clips 805 and clip receivers 806 are included in the housing 101.

The foregoing description of the preferred embodiment of the invention has been presented for purposes of illustration and description. It is not intended to be exhaustive or to limit the invention to the precise forms disclosed, since many modifications or variations thereof are possible in the light of the above teaching. All such modifications and variations are within the scope of the invention. The embodiments described herein were chosen and described in order best to explain the principles of the invention and its practical application, thereby to enable others skilled in the art to utilise the invention in various embodiments and with various modifications as are suited to the particular use contemplated thereof. It is intended that the scope of the invention be defined by the claims appended hereto, when interpreted in accordance with the full breadth to which they are legally and equitably suited.

1. A fastening mechanism for connecting posts or other objects together comprising:
a housing;
a first and second cam oppositely mounted in said housing, said first and second cams having opposed threads; and
a threaded stud having clockwise and counter clockwise portions, said threaded stud connecting said first and second cams allowing said cams to be drawn together in use.

2. A fastening mechanism for connecting posts or other objects together as claimed in claim 1 wherein each said cam has at least one flange in use said at least one flange of said first cam and said at least one flange of said second cam being substantially parallel.

3. A fastening mechanism for connecting posts or other objects together as claimed in claim 2 wherein said at least one flange is two flanges.

4. A fastening mechanism for connecting posts or other objects together as claimed in claim 1 wherein said housing in use prevents said first and second cam rotating relative to each other.

5. A fastening mechanism for connecting posts or other objects together as claimed in claim 4 wherein rotation prevention means in said housing for said first and second cams are offset to allow in use said first and second cams to be drawn closely together.

6. A fastening mechanism for connecting posts or other objects together as claimed in claim 1 wherein said housing is made of mild steel and powder coated.

7. A fastening mechanism for connecting posts or other objects together as claimed in claim 1 wherein said cams are made of mild steel and chrome plated.

8. A fastening mechanism for connecting posts or other objects together as claimed in claim 1 wherein said cams are made of mild steel and blackened.

9. A fastening mechanism for connecting posts or other objects together as claimed in claim 1 wherein said housing comprises first and second shells.

10. A fastening mechanism for connecting posts or other objects together as claimed in claim 9 wherein said first and second shells are held together by clips.

11. A fastening mechanism for connecting posts or other objects together as claimed in claim 9 wherein said housing includes rotation prevention means and said housing and said rotation prevention means comprises one pair of offset slots for each said cam, said housing including ends to prevent each said cam from being accidentally withdrawn from said housing.

12. A fastening mechanism for connecting posts or other objects together as claimed in claim 9 wherein said first and second shells are made of nylon.

13. A method of fastening posts or other objects together using the fastening mechanism of claim 1 wherein each said cam has a pair of flanges, in use said pair of flanges of said first cam and said pair of flanges of said second cam being substantially parallel, said method comprising the steps of:
passing a first said cam and part of said housing through a hole in a first and second post, said hole being sized and shaped to allow said cam flanges and said housing to pass through;
turning said fastening device in said hole so that said cam flanges are not aligned with said hole; and
turning said threaded stud to bring said cams together, said cam flanges pulling said posts together.
